(19) United States
(12) Patent Application Publication
(10) Pub. No.: US 2025/0104472 A1
(43) Pub. Date: Mar. 27, 2025

(54) INFORMATION PROCESSING APPARATUS, AND INFORMATION PROCESSING METHOD

(71) Applicant: TOYOTA JIDOSHA KABUSHIKI KAISHA, Toyota-shi (JP)

(72) Inventors: Teruyoshi FUJIWARA, Toyota-shi (JP); Iwao NITTA, Nagoya-shi (JP); Ryota SUZUKI, Ikeda-shi (JP)

(73) Assignee: TOYOTA JIDOSHA KABUSHIKI KAISHA, Toyota-shi (JP)

(21) Appl. No.: 18/810,749

(22) Filed: Aug. 21, 2024

(30) Foreign Application Priority Data
Sep. 22, 2023 (JP) 2023-159186

(51) Int. Cl. G06V 40/16; G06V 20/59

(52) U.S. Cl. CPC G06V 40/172; G06V 20/59

(57) ABSTRACT

A controller is provided which acquires user identification information that is identification information of a user of a vehicle; acquires an authentication face image that is an image associated with the user identification information and is an image of a face for authentication of the user of the vehicle; acquires a user's face image that is an image generated by photographing the user of the vehicle with a camera disposed outside the vehicle; performs face authentication based on a comparison between the authentication face image and the user's face image; and acquires, from the user's face image, first information to be used in the next and subsequent face authentications in response to the face authentication not being successful.

### CROSS REFERENCE TO THE RELATED APPLICATION

This application claims the benefit of Japanese Patent Application No. 2023-159186, filed on Sep. 22, 2023, which is hereby incorporated by reference herein in its entirety.

### BACKGROUND

### Technical Field

The present disclosure relates to an information processing apparatus, and an information processing method.

### Description of the Related Art

It is known that image data of the faces of workers who are allowed to enter a security area is stored in advance as registration information to perform face authentication processing (see, for example, Patent Literature 1).

### CITATION LIST

### Patent Literature

Patent Literature 1: Japanese Patent Application Laid-Open Publication No. 2022-137959

### SUMMARY

An object of the present disclosure is to improve the accuracy of face authentication.

### Solution to Problem

One aspect of the present disclosure is directed to an information processing apparatus including a controller configured to:
acquire user identification information that is identification information of a user of a vehicle;
acquire an authentication face image that is an image associated with the user identification information and is an image of a face for authentication of the user of the vehicle;
acquire a user's face image that is an image generated by photographing the user of the vehicle with a camera disposed outside the vehicle;
perform face authentication based on a comparison between the authentication face image and the user's face image; and
acquire, from the user's face image, first information that is information to be used in the next and subsequent face authentications in response to the face authentication not being successful.

Another aspect of the present disclosure is directed to an information processing method for causing a computer to:
acquire user identification information that is identification information of a user of a vehicle;
acquire an authentication face image that is an image associated with the user identification information and is an image of a face for authentication of the user of the vehicle;
acquire a user's face image that is an image generated by photographing the user of the vehicle with a camera disposed outside the vehicle;
perform face authentication based on a comparison between the authentication face image and the user's face image; and
acquire, from the user's face image, first information that is information to be used in the next and subsequent face authentications in response to the face authentication not being successful.

A further aspect of the present disclosure is directed to a non-transitory storage medium storing a program for causing a computer to:
acquire user identification information that is identification information of a user of a vehicle;
acquire an authentication face image that is an image associated with the user identification information and is an image of a face for authentication of the user of the vehicle;
acquire a user's face image that is an image generated by photographing the user of the vehicle with a camera disposed outside the vehicle;
perform face authentication based on a comparison between the authentication face image and the user's face image; and
acquire, from the user's face image, first information that is information to be used in the next and subsequent face authentications in response to the face authentication not being successful.

In addition, a still further aspect of the present disclosure is directed to the program described above.

### Advantageous Effects of Invention

According to the present disclosure, it is possible to increase the accuracy of face authentication.

### BRIEF DESCRIPTION OF THE DRAWINGS

FIG. 1 is a view illustrating a schematic configuration of a system according to an embodiment;

FIG. 2 is a view illustrating an outline of processing of the system according to the embodiment;

FIG. 3 is a block diagram schematically illustrating an example of a hardware configuration of each of a center server, a user side server, an association management server, a vehicle ID server, and a payment server which together constitute the system according to the embodiment;

FIG. 4 is a block diagram schematically illustrating an example of a hardware configuration of each of a user terminal and an in-vehicle device according to the embodiment;

FIG. 5 is a diagram schematically illustrating an example of a software configuration of the center server according to the embodiment;

FIG. 6 is a diagram illustrating an example of table configurations of a user information DB and an authentication face image DB according to the embodiment;

FIG. 7 is a diagram schematically illustrating an example of a software configuration of the user side server according to the embodiment;

FIG. 8 is a diagram illustrating an example of table configurations of a first information DB and a second authentication information DB according to the embodiment;

FIG. 9 is a diagram schematically illustrating an example of a software configuration of an in-vehicle device according to the embodiment;

FIG. 10 is a diagram schematically illustrating an example of a software configuration of the user terminal according to the embodiment;

FIG. 11 is a flowchart of user registration processing in the center server according to the embodiment;

FIG. 12 is a flowchart of processing of providing an authentication face image in the center server according to the embodiment;

FIG. 13 is a flowchart of face authentication processing in the user side server according to the embodiment;

FIG. 14 is a diagram illustrating an example of a table configuration of a first information DB according to a second embodiment;

FIG. 15 is a flowchart of face authentication processing in a user side server according to the second embodiment;

FIG. 16 is a diagram illustrating an example of a table configuration of a first information DB according to a third embodiment; and

FIG. 17 is a flowchart of face authentication processing in a user side server according to the third embodiment.

### DESCRIPTION OF THE EMBODIMENTS

According to face authentication systems, a subject (person) can be authenticated even when the subject is far away from the system, as long as the face of the subject can be photographed by a camera. Therefore, face authentication makes it possible to authenticate the subject in a simple and early manner. However, the conventional face authentication systems have the following problems.

That is, in recent years, with advances in machine learning technology, the number of situations in which face authentication can be performed has been increasing. In addition, there are an increasing number of situations, such as for example drive-throughs, where authentication of a subject is recommended while the subject is still in a vehicle, which is increasing the need for face authentication. Therefore, it is assumed that a picture of a subject who gets in a vehicle is taken from outside the vehicle, and a face image of the subject thus obtained is used to authenticate the subject. Thus, a system is assumed to be configured to perform face authentication by comparing a previously obtained authentication face image with the face image obtained at the time of authentication. In this case, the authentication face image is basically obtained by taking a picture of the subject at an optional timing when the subject is not in the vehicle (e.g., the subject takes a picture of himself or herself with a portable or mobile terminal). On the other hand, the face image obtained at the time of authentication reflects components constituting the vehicle, such as for example the windshield, side glasses (windows), etc. In one example, by photographing the subject through the windshield, the face of the subject may appear a different color in the resulting face image than it actually is due to the influence of the color of the windshield. This may result in a significant discrepancy between how the subject appears in the face image obtained at the time of authentication and how the subject appears in the authentication face image, which may result in incorrect face authentication. The present disclosure solves such problems.

Therefore, an information processing apparatus, which is one of the aspects of the present disclosure, includes a controller that is configured to: acquire user identification information that is identification information of a user of a vehicle; acquire an authentication face image that is an image associated with the user identification information and is an image of a face for authentication of the user of the vehicle; acquire a user's face image that is an image generated by photographing the user of the vehicle with a camera disposed outside the vehicle; perform face authentication based on a comparison between the authentication face image and the user's face image; and acquire, from the user's face image, first information that is information to be used in the next and subsequent face authentications in response to the face authentication not being successful.

The user of the vehicle is a user associated with the vehicle. The user may be the owner of the vehicle. The user identification information is information that can identify the user, and may be, for example, information on a user ID that is assigned in advance. Also, as another example, the user identification information may be information on the number of a driver's license. The authentication face image is an image obtained by photographing the face of the user in advance. The authentication face image may be an image obtained by photographing the face of the user himself or herself by using a camera attached to a terminal of the user, for example. In addition, the authentication face image may be registered in advance in association with the user identification information.

Further, the controller acquires a user's face image that is an image generated by photographing the user of the vehicle with a camera disposed outside the vehicle. The user's face image is, for example, a face image of the user at the current point in time. Then, the controller performs face authentication based on a comparison between the authentication face image and the user's face image. At this time, even if the user is a legitimate user, face authentication may not be successful. The causes of this problem are considered to include, for example, a cause that depends on an attribute of the user, a cause that depends on an attribute of the vehicle, a cause that depends on a system that performs face authentication, etc. The cause that depends on the attribute of the user is a cause related to the user such as, for example, the user wearing sunglasses or eyeglasses, the user wearing a mask, the user wearing a hat, the user wearing a beard, or the like. In addition, the cause that depends on the attribute of the vehicle is a cause related to the vehicle such as, for example, the height of the vehicle (vehicle height), the size of the vehicle, the color of the windshield, the color of the side glasses (windows), the position of the wipers, the position of the sun visors, the position of the A-pillars (pillars on both sides of the windshield), or the like. Also, the cause that depends on the attribute of the system is a cause related to the system such as, for example, the height from the ground to the camera, the distance from the camera to the vehicle, the angle of view of the camera, or the like. Due to the influence of these factors, the face of the user captured in the user's face image may be deviated from the face of the user captured in the authentication face image. In that case, the face authentication may not be successful.

Therefore, the controller acquires the first information, which is information used in the next and subsequent face authentications, from the user's face image in response to the fact that the face authentication is not successful. The first information includes information on a cause of the face authentication not being successful. By collecting information about the cause of the face authentication not being successful and using this information in the next and subsequent face authentications, it is possible to suppress the face authentication from not being successful even though the user is a legitimate user. That is, it is possible to improve the accuracy of face authentication in a similar situation.

Hereinafter, embodiments of the present disclosure will be described based on the accompanying drawings. The configurations of the following embodiments are examples, and the present disclosure is not limited to the configurations of the embodiments.

### First Embodiment

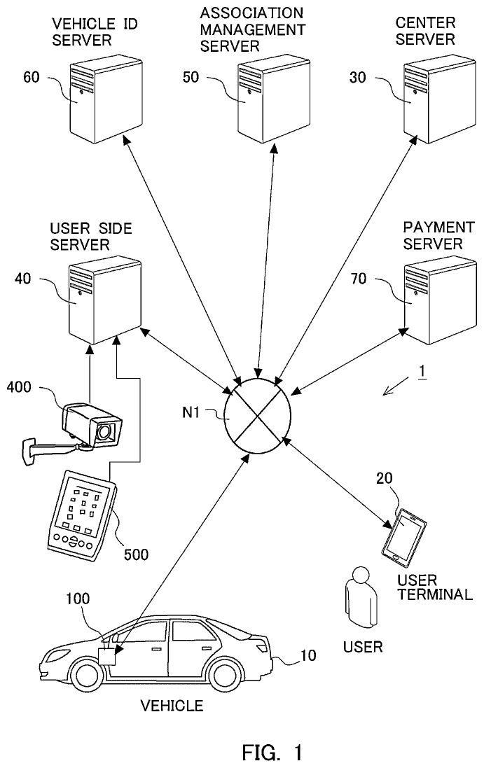

FIG. 1 is a view illustrating a schematic configuration of a system 1 according to an embodiment. In the example of FIG. 1, the system 1 includes an in-vehicle device 100 installed in a vehicle 10, a user terminal 20 possessed by a user of the vehicle 10, a center server 30, a user side server 40, an association management server 50, a vehicle ID server 60, and a payment (or settlement) server 70. The user side server 40 is connected to a camera 400, which captures an image of the inside of the vehicle 10 from the outside of the vehicle 10, and a keypad that allows the user to input numbers.

The in-vehicle device 100, the user terminal 20, the center server 30, the user side server 40, the association management server 50, the vehicle ID server 60, and the payment server 70 are connected to one another by a network N1. Here, note that the network N1 is, for example, a worldwide public communication network such as the Internet or the like, and a WAN (Wide Area Network) or other communication networks may be adopted. Also, the network N1 may include a telephone communication network such as a mobile phone network or the like, and/or a wireless communication network such as Wi-Fi (registered trademark) or the like. FIG. 1 illustrates one vehicle 10 and one user terminal 20 by way of example, but there can be more than one of these. In addition, the in-vehicle device 100 and the user side server 40 or the camera 400 may be capable of short-range wireless or radio communication.

The in-vehicle device 100 is a device that provides information on the vehicle 10 to the user side server 40. The user terminal 20 is a terminal capable of providing a face image of the user. The center server 30 is a server that generates a face image for authentication and provides it to the user side server 40. The user side server 40 is a server that performs face authentication. The association management server 50 is a server that manages the association between the vehicle 10 and the user. The vehicle ID server 60 is a server that manages information on the vehicle 10. The payment server 70 is a server that performs payment.

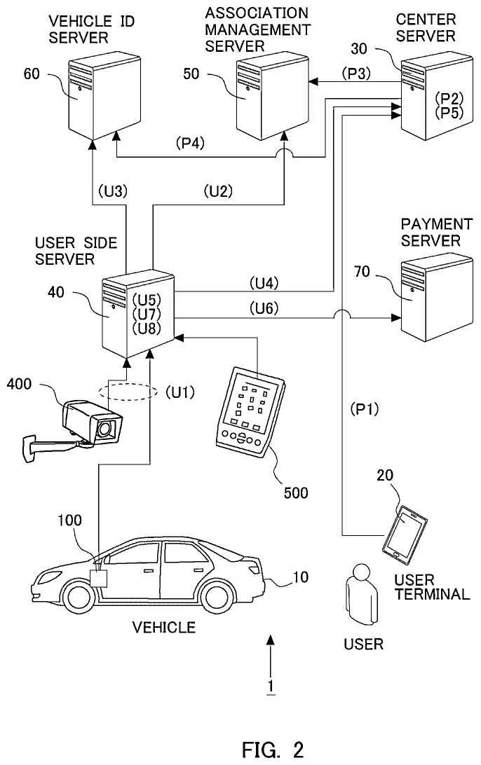

FIG. 2 is a view illustrating an outline of processing of the system 1 according to the embodiment. P1 through P5 are processing related to the center server 30, and U1 through U8 are processing related to the user side server 40. In P1, the user performs user registration in the center server 30 using the user terminal 20. The user requests user registration to the center server 30 via the user terminal 20. At this time, a face image associated with a user ID is transmitted to the center server 30. This face image will also be hereinafter referred to as an authentication face image. The authentication face image is, for example, an image of the face of the user taken by the user terminal 20. However, the authentication face image is not limited to this, but may be an image of the face of the user that has been taken in the past and stored in the user terminal 20 or an external server. Note that the user ID may be, for example, a number assigned by a common number system for identifying an individual in each country (e.g., National Identification Number, Social Security Number, or Citizen Identification Number) or a motor vehicle driver's license number. The user ID is an example of user identification information. In addition, at the time of user registration, information on payment is transmitted from the user terminal 20 to the center server 30 in association with the user ID. The information on payment is information necessary when the user uses a payment service, and includes, for example, a credit card number or a bank account number.

In P2, the center server 30 acquires and stores the user ID, the authentication face image, and the information on payment from the user terminal 20. In P3, the center server 30 requests the association management server 50 to transmit the vehicle ID associated with the user ID. The association management server 50 executes a search by the user ID, and extracts a vehicle ID associated with the user ID. Then, the center server 30 acquires the vehicle ID associated with the user ID from the association management server 50. The vehicle ID is a number unique to the vehicle 10, and is, for example, a chassis number (vehicle identification number) or a number displayed on a motor vehicle registration number certificate (license plate). This number will also be hereinafter referred to as a vehicle number.

In P4, the center server 30 requests the vehicle ID server 60 to transmit the vehicle information associated with the vehicle ID. The vehicle ID server 60 performs a search by the vehicle ID, and extracts the vehicle information associated with the vehicle ID. Then, the center server 30 acquires the vehicle information associated with the vehicle ID from the vehicle ID server 60. The vehicle information includes information that can identify the vehicle, and includes, for example, information on the vehicle type, the vehicle name, the chassis number, or the number on the motor vehicle registration number certificate (vehicle number). Note that the vehicle information may include information that can identify the height and size of the vehicle, the color of the windshield, the color of the side glasses, the position of the wipers, the position of the sun visors, the position of the A-pillars, or the like. In addition, the vehicle information may also include information on the owner of the vehicle 10.

In P5, the center server 30 stores the vehicle information acquired from the vehicle ID server 60. At this time, an attribute of the vehicle 10 may be acquired from the vehicle information and stored. For example, the color of the windshield may be acquired as the attribute of the vehicle 10 from the vehicle information.

In addition, in U1, the user side server 40 acquires the vehicle ID and the face image of the user. The face image of the user is obtained by the camera 400 photographing the user's face from outside of the vehicle 10. The face image acquired in this manner is hereinafter also referred to as a user's face image. Also, the vehicle ID may be acquired from the in-vehicle device 100 through communication. Moreover, as another example, when the vehicle ID corresponds to the vehicle number, the vehicle number may be acquired by analyzing an image of the vehicle 10 taken by the camera 400.

In U2, the user side server 40 inquires of the association management server 50 whether or not there exists an association relationship corresponding to the vehicle ID. At this time, an inquiry may be made as to whether or not a valid association relationship exists at a target date and time. The target date and time may be the date and time at the time of the inquiry (this may be the current date and time), or may be a date and time in the past. The valid association is, for example, an association within an expiration date in cases where the association between the vehicle ID and the user ID has the expiration date. In cases where a valid association exists, the user ID associated with the vehicle ID is transmitted from the association management server 50 to the user side server 40.

In U3, the user side server 40 requests the vehicle ID server 60 to transmit the vehicle information associated with the vehicle ID. The vehicle ID server 60 performs a search by the vehicle ID, and extracts the vehicle information associated with the vehicle ID. Then, the user side server 40 acquires the vehicle information associated with the vehicle ID from the vehicle ID server 60. The vehicle information includes information that can identify the vehicle 10, such as for example information on the vehicle type (model), the vehicle name, the chassis number, or the number on the vehicle registration number certificate (vehicle number). Note that the vehicle information may include information that can identify the height and size of the vehicle 10, the color of the windshield, the color of the side glasses, the position of the wipers, the position of the sun visors, the position of the A-pillars, or the like. In addition, the vehicle information may also include information on the owner of the vehicle 10.

In U4, when there is a valid association relationship, the user side server 40 requests the center server 30 to transmit the authentication face image corresponding to the user ID. The center server 30 transmits the authentication face image corresponding to the user ID to the user side server 40. At this time, the center server 30 also transmits information on various kinds of authorities associated with the user ID to the user side server 40. The various kinds of authorities are, for example, authority for payment services for which the user has registered. Note that the authorities are not limited to this, and may be, for example, authority for administrative services. Also, note that the authentication face image may be stored in the user side server 40 in advance.

In U5, the user side server 40 performs face authentication by comparing the user's face image captured by the camera 400 with the authentication face image. Here, known face authentication techniques can be used. The method of face authentication is not limited. In addition, image processing may also be performed by optional analytical processing (pattern matching, edge extraction, etc.). Also, a pre-trained machine learning model may be used for the image processing.

In U6, when the face authentication is successful, the user side server 40 executes the authority of the user. For example, the user side server 40 requests a payment to the payment server 70. For example, it can be used for payment at a drive-through of a restaurant, payment of parking lot fees, payment of toll road fees or the like.

On the other hand, in U7, when the face authentication is not successful, the user side server 40 performs a second authentication. For example, the user side server 40 may perform the second authentication by means of password input to a keypad 500, fingerprint authentication, voiceprint authentication, or the like. In this case, for example, the user may be notified to input a personal identification number or password number to the keypad 500 disposed in the vicinity of the stop position of the vehicle 10. This notification can be made by playing a voice message or by displaying the message on a signage screen. Also, a device for reading the fingerprint of the user may be disposed in the vicinity of the stop position of the vehicle 10, so that the user may be notified to input his or her fingerprint by the device. In addition, a microphone for inputting the voice of the user may be disposed in the vicinity of the stop position of the vehicle 10, so that the user may be notified to input his or her voice into the microphone. As another example, the user side server 40 may transmit a command to the user terminal 20 or the in-vehicle device 100 so as to acquire the user's password, fingerprint, or voice from the user terminal 20 or the in-vehicle device 100. Then, the user side server 40 may acquire the user's password, fingerprint, or voice from the user terminal 20 or the in-vehicle device 100. As a further example, the user side server 40 may perform SMS authentication using the user terminal 20, authentication using a telephone, or authentication using an email. In this way, the user side server 40 authenticates the user through the second authentication, which is another authentication other than face authentication.

In U8, when the second authentication is successful, the user side server 40 generates and stores first information from the user's face image. The user side server 40 extracts, for example, the color of the windshield of the vehicle 10 and stores information on the color of the windshield as the first information. Note that the user side server 40 may transmit the first information to the center server 30 in association with the user ID, so that the first information may be stored in the center server 30. Thereafter, the user side server 40 executes the authority of the user in the same manner as in U6.

In addition, when the first information already exists in the user side server 40, the user side server 40 generates a processed authentication face image by reflecting the first information in the authentication face image in U5. Then, the user side server 40 performs face authentication by comparing the user's face image captured by the camera 400 with the processed authentication face image.

Here, note that the processed authentication face image may be generated by either the center server 30 or the user side server 40. Also, the processed authentication face image may be stored in either the center server 30 or the user side server 40. In addition, the processed authentication face image should be generated before the face authentication is performed. For example, the processed authentication face image may be generated and stored in the user side server 40 or the center server 30 in response to the acquisition of the first information by the user side server 40 or the center server 30. Further, when one user owns a plurality of vehicles 10, the user side server 40 or the center server 30 may generate and store the first information or the processed authentication face image for each vehicle 10.

Moreover, the first information to be reflected upon generation of the processed authentication face image may be the color of the windshield or side glasses, or may be information that depends on the attribute of the vehicle 10, such as the position and shape of the windshield wipers, sun visors, A-pillars, or front seats, or the height of the vehicle. As another example, the first information may be information that depends on the attribute of the user or information that depends on the attribute of the system 1. The information that depends on the attribute of the user is information related to the user such as, for example, the user wearing sunglasses or eyeglasses, the user wearing a mask, the user wearing a hat, the user wearing a beard, or the like. Also, the information that depends on the attribute of the system is, for example, information related to the system such as the height from the ground to the camera, the distance from the camera to the vehicle, the angle of view of the camera or the like. In addition, any other information that affects at the time of the face authentication can be used as the first information. Then, the processed authentication face image may be generated by reflecting the first information. The user side server 40 may generate the processed authentication face image by, for example, processing the authentication face image so as to add the wipers, the sun visors, the A-pillars, or the front seats.

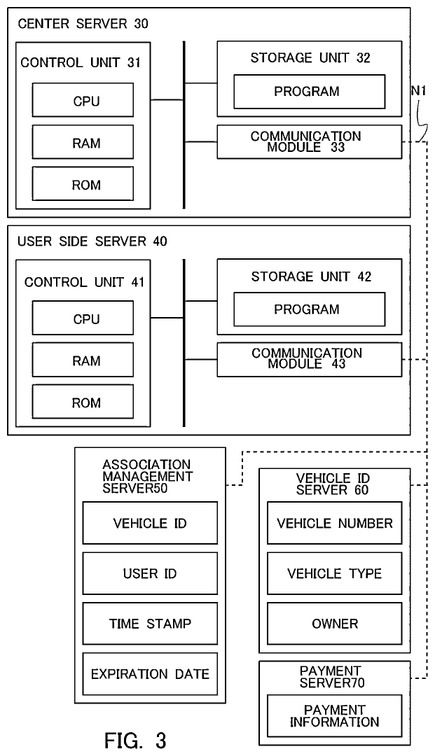

Next, FIG. 3 is a block diagram schematically illustrating an example of a hardware configuration of each of the center server 30, the user side server 40, the association management server 50, the vehicle ID server 60, and the payment server 70, which together constitute the system 1 according to the embodiment.

The center server 30 is configured as a computer including a control unit 31, a storage unit 32, and a communication module 33. The center server 30 can be configured as a computer including a processor (CPU, GPU, etc.), a main storage device (RAM, ROM, etc.), and an auxiliary storage device (EPROM, hard disk drive, removable medium, etc.). An operating system (OS), various kinds of programs, various kinds of tables and the like are stored in the auxiliary storage device, and by executing the programs stored therein, it is possible to implement each function (software module) that meets a predetermined purpose, as will be described later. However, some or all of the modules may be implemented as hardware modules by means of hardware circuits such as ASICs, FPGAs, etc.

The control unit 31 is an arithmetic unit that implements the various functions of the center server 30 by executing predetermined programs. The control unit 31 can be implemented by, for example, a hardware processor such as a CPU or the like. Also, the control unit 31 may be configured to include a RAM, a ROM (Read Only Memory), a cache memory, and the like.

The storage unit 32 is a means to store information, and is constituted by a storage medium such as a RAM, a magnetic disk, a flash memory or the like. The storage unit 32 stores programs to be executed by the control unit 31, data to be used by the programs, etc. In addition, the storage unit 32 stores various kinds of information. Details will be described later.

The communication module 33 is a communication interface for connecting the center server 30 to a network. The communication module 33 may be configured to include, for example, a network interface board, a wireless communication interface for wireless communication, and the like. The center server 30 can perform data communication with other computers (e.g., other server devices, each user terminal 20 or the like) via the communication module 33.

Here, note that the specific hardware configuration of the center server 30 can be changed such that some of its components can be omitted, replaced, or added as appropriate, according to its implementation. For example, the control unit 31 may include a plurality of hardware processors. The hardware processors may be composed of microprocessors, FPGAs, GPUs, or the like. Also, the center server 30 may be composed of a plurality of computers. In this case, the hardware configuration of each computer may be the same or different from each other.

The user side server 40 is configured as a computer including a control unit 41, a storage unit 42, and a communication module 43. The user side server 40 can be configured as a computer including a processor (CPU, GPU, etc.), a main storage device (RAM, ROM, etc.), and an auxiliary storage device (EPROM, hard disk drive, removable medium, etc.). An operating system (OS), various kinds of programs, various kinds of tables and the like are stored in the auxiliary storage device, and by executing the programs stored therein, it is possible to implement each function (software module) that meets a predetermined purpose, as will be described later. However, some or all of the modules may be implemented as hardware modules by means of hardware circuits such as ASICs, FPGAs, etc. The control unit 41, the storage unit 42, and the communication module 43 of the user side server 40 have the same configurations as the control unit 31, the storage unit 32, and the communication module 33 of the center server 30, and thus the description thereof will be omitted.

The camera 400 and the keypad 500 are connected to the user side server 40, and these are controlled by the control unit 41. The camera 400 is disposed in advance at a position where it can take an image of the driver of the stopped vehicle 10. The camera 400 is a device that takes an image by using an imaging element such as a CCD (Charge Coupled Device) image sensor, a CMOS (Complementary Metal Oxide Semiconductor) image sensor or the like. The keypad 500 is disposed in the vicinity of the stop position of the vehicle 10 in advance so as to be operable by the driver of the vehicle 10. The keypad 500 is configured to allow entry of numbers from 0 to 9, for example. Also, the keypad 500 may have a display showing the numbers entered. In addition, the keypad 500 may include a device for input, such as a mouse, a keyboard, or a microphone.

The association management server 50, the vehicle ID server 60, and the payment server 70 can each be configured as a computer similar to the center server 30. The association management server 50 is a device that provides information on each of an association between the vehicle ID and the user ID, a time stamp of this association, and an expiration date of this association via the network N1. Therefore, the association management server 50 stores information on each of the vehicle ID, the user ID, the time stamp, and the expiration date in association with each other. The time stamp is, for example, the date and time when the user ID and the vehicle ID are associated with each other. The expiration date is the validity period of the association between the user ID and the vehicle ID. The association management server 50 is managed by a business operator or a government agency that is neutral with respect to the administrator of the center server 30 and the administrator of the user side server 40. The information stored in the association management server 50 may be provided by the user via the user terminal 20 or may be provided by the center server 30, for example.

The vehicle ID server 60 is a device that provides information on each of the vehicle number, the vehicle type, and the owner of the vehicle 10, which are associated with the vehicle ID, via the network N1. Therefore, the vehicle ID server 60 stores information on each of the vehicle ID, the vehicle number, the vehicle type, and the owner of the vehicle 10 in a mutually associated manner. The vehicle ID server 60 is managed by a business operator or administrative agency that is neutral with respect to the administrator of the center server 30 and the administrator of the user side server 40. The vehicle ID server 60 may be a server managed by an administrative agency that issues a license plate, for example. When the user registers the vehicle 10, a license plate is issued, and information on the number of the license plate (vehicle number), the vehicle type, and the owner may be stored in the vehicle ID server 60.

The payment server 70 is a device that performs payment processing based on a request for payment. The payment server 70 is managed by, for example, a credit card company. As another example, the payment server 70 may be a server that manages electronic money or points, or a server that manages bank deposits. The payment server 70 stores payment information. The payment information may include, for example, information on the association between the user ID and the credit card number.

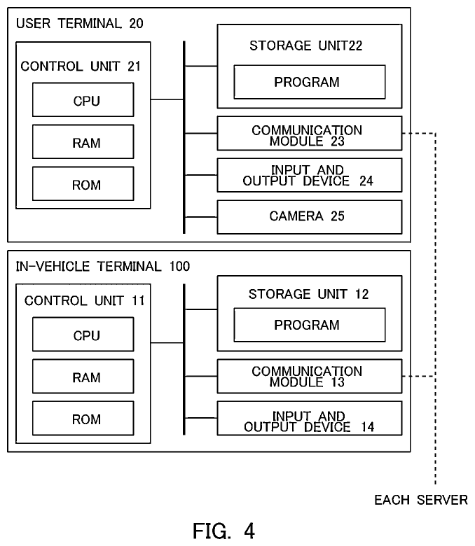

Next, FIG. 4 is a block diagram schematically illustrating an example of a hardware configuration of each of the user terminal 20 and the in-vehicle device 100 according to the present embodiment.

The user terminal 20 is a small computer such as, for example, a smart phone, a mobile phone, a tablet terminal, a personal information terminal, a wearable computer (a smart watch or the like), a personal computer (PC), etc. The user terminal 20 is configured to include a control unit 21, a storage unit 22, a communication module 23, an input and output device 24, and a camera 25.

The user terminal 20, similar to the center server 30, can be configured as a computer having a processor (CPU, GPU, etc.), a main storage device (RAM, ROM, etc.), and an auxiliary storage device (EPROM, hard disk drive, removable medium, etc.). However, some or all of the functions (software modules) may be implemented as hardware modules by means of hardware circuits such as ASICs, FPGAs, etc.

The control unit 21, the storage unit 22, and the communication module 23 of the user terminal 20 have the same configurations as the control unit 31, the storage unit 32, and the communication module 33 of the center server 30, and hence, the description thereof will be omitted.

The input and output device 24 is a means of accepting input operations performed by the user and presenting information to the user. Specifically, the input and output device 24 includes a device for input, such as a mouse, a keyboard, a microphone or the like, and a device for output, such as a display, a speaker or the like. The input and output device 24 may be integrally configured by, for example, a touch panel display or the like. The camera 25 is a device that takes an image by using an imaging element such as, for example, a CCD (Charge Coupled Device) image sensor, a CMOS (Complementary Metal Oxide Semiconductor) image sensor or the like.

Note that the specific hardware configuration of the user terminal 20 can be changed such that some of its components can be omitted, replaced, or added as appropriate according to its implementation, as in the case of the center server 30.

Next, the in-vehicle device 100 is a computer such as, for example, an ECU (Electronic Control Unit), a DCM (Data Communication Module), a head unit, a navigation system or the like, which is mounted on the vehicle 10. The in-vehicle device 100 is configured to include a control unit 11, a storage unit 12, a communication module 13, and an input and output device 14. The control unit 11, the storage unit 12, the communication module 13, and the input and output device 14 of the in-vehicle device 100 are the same as the control unit 21, the storage unit 22, the communication module 23, and the input and output device 24 of the user terminal 20, and thus, the description thereof will be omitted.

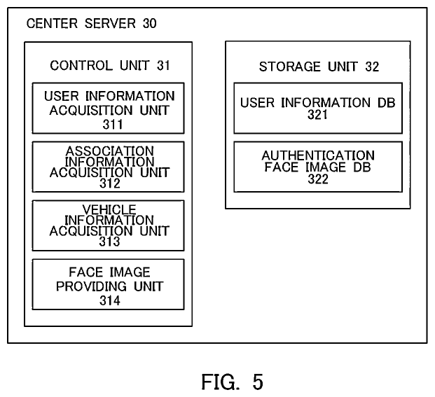

FIG. 5 is a diagram schematically illustrating an example of a software configuration of the center server 30 according to the embodiment. The control unit 31 is configured to include software modules of a user information acquisition unit 311, an association information acquisition unit 312, a vehicle information acquisition unit 313, and a face image providing unit 314. Each software module may be implemented by the control unit 31 (CPU) executing a program stored in the storage unit 32. Note that information processing executed by the user information acquisition unit 311, the association information acquisition unit 312, the vehicle information acquisition unit 313, and the face image providing unit 314, which will be described below, is synonymous with information processing executed by the control unit 31.

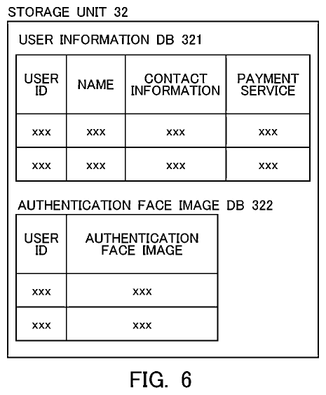

The storage unit 32 of the center server 30 stores a user information database 321 (hereinafter, referred to as a user information DB 321) and an authentication face image database 322 (hereinafter, referred to as an authentication face image DB 322). The user information DB 321 and the authentication face image DB 322 are constructed by a program of a database management system (DBMS), which is executed by a processor to manage the data stored in the auxiliary storage device. These databases are, for example, relational databases. FIG. 6 is a diagram illustrating an example of table configurations of the user information DB 321 and the authentication face image DB 322 according to the embodiment. Details will be described later.

The user information acquisition unit 311 is configured to receive user information and an authentication face image transmitted from the user terminal 20 of the user, and to perform the processing of storing the user information and the authentication face image in the user information DB 321 and the authentication face image DB 322. As illustrated in FIG. 6, the user information DB 321 stores user IDs, the names of users, the contact information of the users, and information on payment services. The user information of the user is associated with the user ID thereof. The user ID may be, for example, the number of a motor vehicle driver's license. Also, the contact information of the user may include an address, a telephone number, an SNS account, and an email address of the user. The information on the payment services of the user is information on the association between the user and the payment services, and includes information on the payment desired by the user at the time of payment (e.g., a credit card number). The user information is registered in advance in the center server 30 by the user via the user terminal 20. In addition, as illustrated in FIG. 6, the authentication face image DB 322 stores the authentication face image in association with the user ID. The authentication face image is the face image of the user transmitted from the user terminal 20 together with the user information, and is, for example, the face image captured by the user himself or herself with the camera 25 of the user terminal 20. The user information acquisition unit 311 stores the authentication face image received from the user terminal 20 in the authentication face image DB 322 in association with the user ID. Note that as another example, the authentication face image DB 322 may store information about a location where the authentication face image is stored.

The association information acquisition unit 312 requests the association management server 50 to perform a search using the user ID. Then, the association management server 50 returns to the center server 30 information (hereinafter, also referred to as association information) on each of the vehicle ID, the time stamp, and the expiration date, which are associated with the user ID. Note that the association management server 50 may periodically update the association between the user IDs and the vehicle IDs. The association information acquisition unit 312 stores the association information acquired from the association management server 50 in the storage unit 32.

The vehicle information acquisition unit 313 requests the vehicle ID server 60 to perform a search by the vehicle ID. This vehicle ID is the vehicle ID acquired from the association management server 50. Then, the vehicle ID server 60 returns to the center server 30 information on each of the vehicle number, the vehicle type, and the owner of the vehicle 10 associated with the vehicle ID. The vehicle type is classified in such a manner that the attribute of the vehicle 10 can be determined, for example. The information on the owner of the vehicle 10 includes, for example, information on the user ID or name. The vehicle information acquisition unit 313 stores in the storage unit 32 information on each of the vehicle number, the vehicle type, and the owner of the vehicle 10, which are associated with the vehicle ID acquired from the vehicle ID server 60.

The face image providing unit 314 provides an authentication face image in response to a request from the user side server 40. The request from the user side server 40 includes information on the user ID or the vehicle ID, and the face image providing unit 314 extracts an authentication face image corresponding to the user ID or the vehicle ID from the authentication face image DB 322 and transmits the authentication face image thus extracted to the user side server 40.

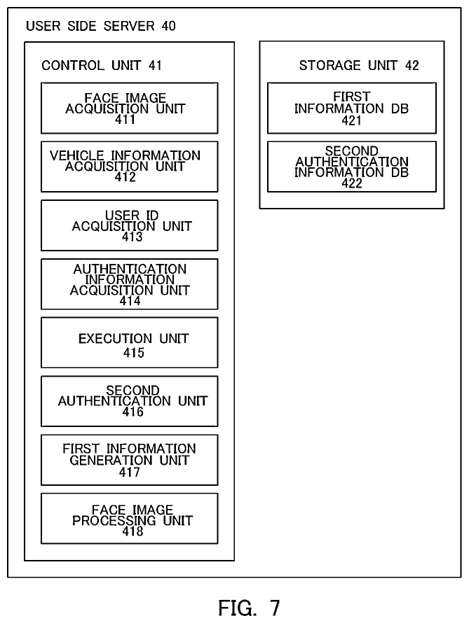

FIG. 7 is a diagram schematically illustrating an example of a software configuration of the user side server 40 according to the embodiment. The control unit 41 is configured to include software modules of a face image acquisition unit 411, a vehicle information acquisition unit 412, a user ID acquisition unit 413, an authentication information acquisition unit 414, an execution unit 415, a second authentication unit 416, a first information generation unit 417, and a face image processing unit 418. The software modules may each be implemented by the control unit 41 (CPU) executing a program stored in the storage unit 42. Note that the information processing executed by the face image acquisition unit 411, the vehicle information acquisition unit 412, the user ID acquisition unit 413, the authentication information acquisition unit 414, the execution unit 415, the second authentication unit 416, the first information generation unit 417, and the face image processing unit 418 is synonymous with the information processing executed by the control unit 41.

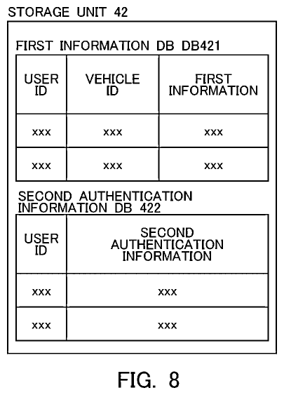

The storage unit 42 of the user side server 40 stores a first information database 421 (hereinafter, referred to as a first information DB 421) and a second authentication information database 423 (hereinafter, referred to as a second authentication information DB 423). The first information DB 421 and the second authentication information DB 423 are constructed by a program of the database management system (DBMS), which is executed by a processor to manage the data stored in the auxiliary storage device. These databases are, for example, relational databases. FIG. 8 is a diagram illustrating an example of table configurations of the first information DB 421 and the second authentication information DB 423 according to the embodiment. Details will be described later.

The face image acquisition unit 411 acquires an image captured by the camera 400 when the vehicle 10 exists at a predetermined position. The camera 400 is disposed in advance in a position where it can capture an image of the driver of the vehicle 10. The face image acquisition unit 411 constantly monitors the image captured by the camera 400, for example, and detects by image analysis that the vehicle 10 has approached the predetermined position. Then, the image of the user captured at that time is acquired as a user's face image.

The vehicle information acquisition unit 412 acquires information on the vehicle 10 existing at the predetermined position. In this case, for example, the camera 400 may be equipped with a wireless communication function, so that wireless communication between the camera 400 and the vehicle 10 may be made to obtain information on the vehicle 10 (e.g., the vehicle number). Also, as another example, the vehicle number may be read by analyzing an image of the vehicle 10 captured by the camera 400.

The user ID acquisition unit 413 requests the association management server 50 to perform a search by the vehicle ID. At this time, the user ID acquisition unit 413 inquires of the association management server 50 whether or not a valid association relationship corresponding to the vehicle ID exists at a target date and time. When a valid association relationship corresponding to the vehicle ID exists at the target date and time, the association management server 50 returns the user ID associated with the vehicle ID to the user side server 40. The user ID acquisition unit 413 stores the user ID acquired from the association management server 50 in the storage unit 42. Note that the user ID acquisition unit 413 may acquire information on the user ID from the in-vehicle device 100 or the user terminal 20.

The authentication information acquisition unit 414 requests the center server 30 to perform a search by the user ID. The center server 30 returns to the user side server 40 information on the various kinds of authorities associated with the user ID and the authentication face image. The various kinds of authorities include, for example, information on a payment service associated with the user ID.

When the face authentication is successful and the authorities are valid, the execution unit 415 requests a payment to the payment server 70. The execution unit 415 performs the face authentication by comparing the authentication face image acquired from the center server 30 or the processed authentication face image generated by the face image processing unit 418 to be described later with the user's face image acquired from the camera 400. When the first information exists, the execution unit 415 performs the face authentication based on the processed authentication face image, whereas when the first information does not exist, the execution unit 415 performs the face authentication based on the authentication face image. The payment server 70 to which the payment is requested is selected by the execution unit 415 based on the information on the various kinds of authorities associated with the user ID.

When the face authentication is not successful, the second authentication unit 416 performs a second authentication other than the face authentication. The second authentication is an authentication by a method other than the face authentication. The second authentication unit 416 may notify the user to input a password number to the keypad 500, for example. Then, the second authentication unit 416 performs the authentication by comparing the number input to the keypad 500 with the number stored in the second authentication information DB 324 of the storage unit 32, for example. As illustrated in FIG. 8, the second authentication information DB 324 stores the second authentication information in association with the user ID. Note that the second authentication is not limited to this, but may be any authentication method other than the face authentication, such as fingerprint authentication, voiceprint authentication, SMS authentication, authentication by telephone, or the like. When the authentication by the second authentication unit 416 is successful and the authorities are valid, the execution unit 415 requests a payment to the payment server 70.

The first information generation unit 417 generates the first information when the face authentication is not successful and the second authentication is successful. The first information is, for example, information on the color of the windshield of the vehicle 10. The first information generation unit 417 generates the first information by extracting information on the color of the windshield from the user's face image using a known technique. Then, the first information generation unit 417 stores the first information thus generated in the first information DB 421 by associating it with the user ID and the vehicle ID. As illustrated in FIG. 8, the first information DB 421 stores information on user IDs, vehicle IDs, and first information. In cases where the same user owns a plurality of vehicles 10, there will be a plurality of records having the same user ID and different vehicle IDs. Note that the first information may be generated by the control unit 31 of the center server 30, instead of the first information generation unit 417 of the user side server 40. In this case, in response to the face authentication not being successful, the user's face image is associated with the user ID and the vehicle ID and transmitted to the center server 30. As another example, the first information generation unit 417 may generate the first information from the user's face image and transmit the first information to the center server 30. Then, the first information may be stored in the storage unit 32 of the center server 30.

The face image processing unit 418 generates the processed authentication face image by processing the authentication face image acquired from the center server 30 in accordance with the first information. As illustrated in FIG. 8, the first information DB 421 stores relationships among user IDs, vehicle IDs, and first information. When acquiring the authentication face image, the face image processing unit 418 extracts the first information corresponding to the user ID and the vehicle ID from the first information DB 421. Then, the processed authentication face image is generated by reflecting the first information on the authentication face image. For example, in cases where the color of the windshield of the vehicle 10 is stored as the first information in the first information DB 421, the face image processing unit 418 generates the processed authentication face image by reflecting the color of the windshield of the vehicle 10 on the authentication face image. That is, the processed authentication face image is generated so as to correspond to the image obtained by capturing the face of the user from the outside of the vehicle 10. The face image processing unit 418 stores the processed authentication face image thus generated in the storage unit 42 by associating it with the vehicle ID and the user ID.

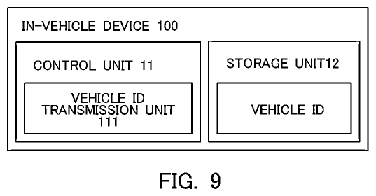

FIG. 9 is a diagram schematically illustrating an example of a software configuration of the in-vehicle device 100 according to the embodiment. In the present embodiment, the control unit 11 of the in-vehicle device 100 is configured to include a software module of a vehicle ID transmission unit 111. The software module may be implemented by the control unit 11 (CPU) executing a program stored in the storage unit 12. Note that the information processing performed by the vehicle ID transmission unit 111 to be described below is synonymous with the information processing performed by the control unit 11.

The vehicle ID transmission unit 111 transmits a vehicle ID stored in the storage unit 12 to the user side server 40 or the camera 400 in response to a request from the user side server 40 or the camera 400. Note that in cases where the vehicle information acquisition unit 412 of the user side server 40 reads and acquires the vehicle number, the vehicle ID transmission unit 111 can be omitted.

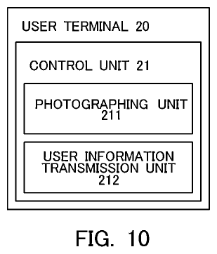

FIG. 10 is a diagram schematically illustrating an example of a software configuration of the user terminal 20 according to the embodiment. The control unit 21 of the user terminal 20 is configured to include software modules of a photographing unit 211 and a user information transmission unit 212. Each software module may be implemented by the control unit 21 (CPU) executing a program stored in the storage unit 22. Note that the information processing performed by the photographing unit 211 and the user information transmission unit 212 to be described below is synonymous with the information processing performed by the control unit 21.

The photographing unit 211 photographs or captures the user with the camera 25. The photographing unit 211 takes a picture when the user makes a predetermined input to the input and output device 24. At this time, the user adjusts the angle of the camera 25 so as to capture his or her own face.

The user information transmission unit 212 transmits the user information input by the user via the input and output device 24 and the user's face image captured by the photographing unit 211 to the center server 30. In addition, in cases where the second authentication is SMS authentication or telephone authentication, the user information transmission unit 212 may transmit the information input to the input and output device 24 by the user in the SMS authentication or telephone authentication to the user side server 40.

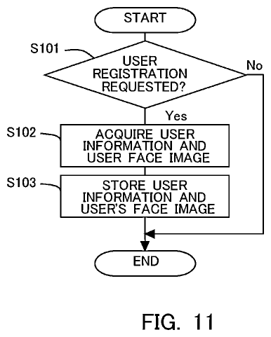

Next, registration processing of the user in the center server 30 will be described. FIG. 11 is a flowchart of the user registration processing in the center server 30 according to the embodiment. The processing illustrated in FIG. 11 is carried out in the center server 30 at predetermined time intervals. Note that the processing illustrated in FIG. 11 is performed by each software module of the control unit 31, but in the following flowchart, description will be given assuming that the control unit 31 performs the processing.

In step S101, the control unit 31 determines whether or not a request for user registration has been received from the user terminal 20. An application program capable of performing user registration may be installed in the user terminal 20. By using this application program, the user makes a predetermined input and takes a picture of his or her face, so that a request for user registration is transmitted from the user terminal 20 to the center server 30. Also, as another example, the user may access from the user terminal 20 a web page on which user registration can be performed, so that the user may make a predetermined input on the web page or upload an authentication face image, thereby transmitting a request for user registration from the user terminal 20 to the center server 30. When an affirmative determination is made in step S101, the processing proceeds to step S102, whereas when a negative determination is made, this routine is ended.

In step S102, the control unit 31 acquires user information and an authentication face image. The user information and the authentication face image are transmitted from the user terminal 20 to the center server 30 together with a request for user registration, so that the control unit 31 acquires the user information and the authentication face image thus transmitted. The user information includes a user ID. Then, in step S103, the control unit 31 performs registration processing for the user, stores the user information in the user information DB 321, and also stores the authentication face image in the authentication face image DB 322 in association with the user ID.

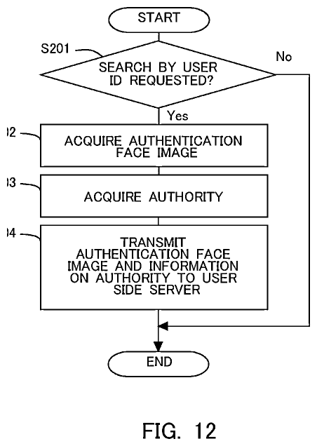

Next, the processing of providing the authentication face image in the center server 30 will be described. FIG. 12 is a flowchart of the processing of providing the authentication face image in the center server 30 according to the embodiment. The processing illustrated in FIG. 12 is carried out in the center server 30 at predetermined time intervals. Note that the processing illustrated in FIG. 12 is performed by each software module of the control unit 31, but in the following flowchart, description will be given assuming that the control unit 31 performs the processing.

In step S201, the control unit 31 determines whether or not a request for a search by the user ID has been received from the user side server 40. This request includes a request to transmit information on the various kinds of authorities associated with the user ID and the authentication face image to the user side server 40. When an affirmative determination is made in step S201, the processing proceeds to step S202, whereas when a negative determination is made, this routine is ended.

In step S202, the control unit 31 acquires the authentication face image stored in the authentication face image DB 322. The authentication face image acquired at this time is the face image received from the user terminal 20 at the time of user registration. The control unit 31 extracts, from the authentication face image DB 322, the authentication face image associated with the user ID acquired in step S201.

In step S203, the control unit 31 acquires the authority of the user from the user information DB 321. In the present embodiment, information on a payment service is acquired as the information on the authority of the user. Then, in step S204, the control unit 31 transmits the authentication face image and the information on the authority of the user to the user side server 40. The information on the authority of the user to be transmitted at this time includes, for example, information on a payment company (credit card company) registered by the user, information on a credit card number, and the like.

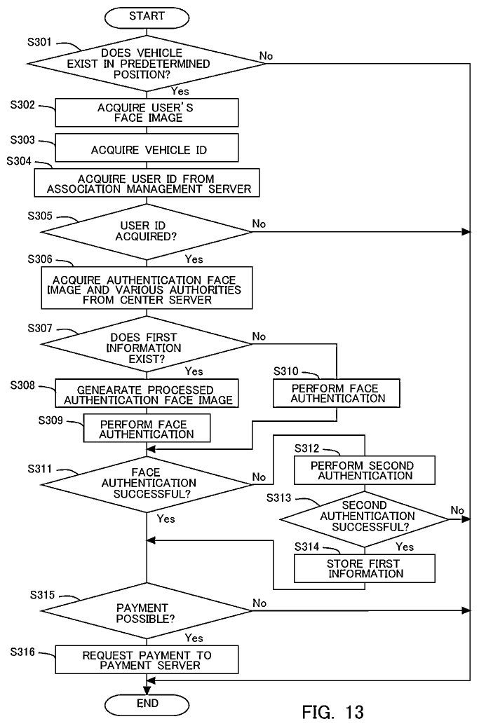

Next, the processing of face authentication in the user side server 40 will be described. FIG. 13 is a flowchart of the processing of face authentication in the user side server 40 according to the embodiment. The processing illustrated in FIG. 13 is carried out in the user side server 40 at predetermined time intervals. Note that the processing illustrated in FIG. 13 is performed by each software module of the control unit 41, but in the following flowchart, description will be given assuming that the control unit 41 performs the processing.

In step S301, the control unit 41 determines whether or not the vehicle 10 exists at a predetermined position. The predetermined position is a position where the camera 400 can capture the face of the driver of the vehicle 10. The predetermined position may be, for example, a position at which an item is ordered or a position at which an item is received at a drive-through. Note that the predetermined position is not limited to a position at which the vehicle 10 stops, but may be a position through which the vehicle 10 passes during traveling. When an affirmative determination is made in step S301, the processing proceeds to step S302, whereas when a negative determination is made, this routine is ended.

In step S302, the control unit 41 acquires a user's face image by capturing the driver of the vehicle 10 with the camera 400. The control unit 41 stores the user's face image thus acquired in the storage unit 42. In step S303, the control unit 41 acquires a vehicle ID from the vehicle 10. For example, the vehicle ID may be transmitted from the in-vehicle device 100 to the camera 400 using short-range wireless or radio communication. As another example, the camera 400 may capture a license plate of the vehicle 10 to acquire the vehicle number by image analysis.

In step S304, the control unit 41 acquires a user ID corresponding to the vehicle ID from the association management server 50. At this time, the control unit 41 inquires of the association management server 50 whether or not a valid association relationship corresponding to the vehicle ID exists at a target date and time. In this case, the control unit 41 transmits information on the vehicle ID and the target date and time to the association management server 50. For example, if the user has not registered a user ID, there is no valid association relationship corresponding to the vehicle ID. Therefore, in the association management server 50, it is determined whether or not there exists a user ID corresponding to the vehicle ID. Also, for example, an expiration date may be set for the association between the vehicle ID and the user ID. In this case, if the expiration date of the association between the vehicle ID and the user ID has passed, there is no valid association relationship corresponding to the vehicle ID. Therefore, in the association management server 50, it is determined whether or not the association between the vehicle ID and the user ID is within the expiration date. In addition, for example, in the case where a valid association relationship between the vehicle ID and the user ID is required at a specific date and time, a time stamp is used to determine whether or not a valid association relationship between the vehicle ID and the user ID exists at that specific date and time. When a valid association relationship between the vehicle ID and the user ID exists at the target date and time, the association management server 50 transmits the user ID to the user side server 40. On the other hand, when there exists no valid association relationship between the vehicle ID and the user ID at the target date and time, the association management server 50 sends information to that effect to the user side server 40. In this case, the control unit 41 cannot acquire the user ID corresponding to the vehicle ID. Note that as another example, the control unit 41 may acquire a user ID from the in-vehicle device 100 or the user terminal 20. For example, the user ID may be registered in the in-vehicle device 100 in advance in association with the vehicle ID, and the user ID may be transmitted to the camera 400 together with the vehicle ID.

In step S305, the control unit 41 determines whether or not the user ID has been acquired in step S304. When an affirmative determination is made in step S305, the processing proceeds to step S306, whereas when a negative determination is made, this routine is ended. Note that when a negative determination is made in step S305, the user may be notified that payment cannot be made. The user side server 40 may be configured, for example, to display a signage to that effect or play a voice message to that effect from a speaker.

In step S306, the control unit 41 acquires an authentication face image and information on various kinds of authorities from the center server 30. At this time, the control unit 41 transmits a request for a search by the user ID to the center server 30. In response to this request, the center server 30 transmits to the user side server 40 an authentication face image and information on various kinds of authorities, corresponding to the user ID. Then, the control unit 41 receives the authentication face image and the information on the various kinds of authorities of the user from the center server 30.

In step S307, the control unit 41 determines whether or not there exists first information corresponding to the user. The control unit 41 accesses the first information DB 421 and determines whether or not there exists a record including the user ID corresponding to the user. When this record exists, the control unit 41 determines that the first information corresponding to the user exists. On the other hand, when this record does not exist, the control unit 41 determines that the first information corresponding to the user does not exist. When an affirmative determination is made in step S307, the processing proceeds to step S308, whereas when a negative determination is made, the processing proceeds to step S310.

In step S308, the control unit 41 generates a processed authentication face image by processing the authentication face image using the first information. For example, the control unit 41 processes the authentication face image acquired from the center server 30 in such a way that the processed authentication face image becomes the face image of the user when the user is photographed through the windshield. Known techniques can be used for this processing. The control unit 41 stores the processed authentication face image thus generated in the storage unit 42.

In step S309, the control unit 41 performs face authentication by comparing the user's face image acquired in step S302 with the processed authentication face image generated in step S308. On the other hand, in step S310, the control unit 41 performs face authentication by comparing the user's face image acquired in step S302 with the authentication face image acquired in step S306. Known techniques can be employed for these face authentications. The method of face authentication is not particularly limited, but may be determined as appropriate according to its implementation.

In step S311, the control unit 41 determines whether or not the face authentication is successful. When an affirmative determination is made in step S311, the processing proceeds to step S315, whereas when a negative determination is made, the processing proceeds to step S312.

In step S312, the control unit 41 performs a second authentication. For example, the control unit 41 notifies the user to input a password number to the keypad 500. The user side server 40 may be configured, for example, to display a signage to that effect or play a voice message to that effect from a speaker. Then, the control unit 41, which has acquired the password number input by the user via the keypad 500, performs the second authentication by comparing it with the password number corresponding to the user ID stored in the second authentication information DB. When both the password numbers match, the second authentication is successful. Then, in step S313, the control unit 41 determines whether or not the second authentication is successful. When an affirmative determination is made in step S313, the processing proceeds to step S314, whereas when a negative determination is made, this routine is ended. Here, note that when a negative determination is made in step S313, the control unit 41 may notify the user that payment cannot be made.

In step S314, the control unit 41 stores the first information in the first information DB 421. Note that the first information may be, for example, information on the color of the windshield extracted from the user's face image. As another example, the first information may be the user's face image. The control unit 41 stores the first information in the first information DB 421 in association with the vehicle ID and the user ID.

In step S315, the control unit 41 determines whether or not the user can make a payment at the payment server 70. The control unit 41 determines whether or not the user's authority for payment is valid, based on the information on the various kinds of authorities acquired from the center server 30. In this case, the control unit 41 may inquire of the payment server 70 whether or not the user can make a payment at the payment server 70. When an affirmative determination is made in step S315, the processing proceeds to step S316, whereas when a negative determination is made, this routine is ended.

In step S316, the control unit 41 requests a payment to the payment server 70. That is, the user's authority is executed. At this time, the user ID and information on an amount of money to be paid are transmitted to the payment server 70.

In this way, when the face authentication by the control unit 41 is not successful, the first information is collected. Then, in the next and subsequent face authentications, face authentication is performed based on the processed authentication face image that reflects the first information, and thus it is possible to improve the accuracy of the face authentication. That is, it is possible to suppress the discrepancy between how the user appears in the user's face image obtained at the time of face authentication and how the user appears in the processed authentication face image. Accordingly, it is possible to improve the accuracy of face authentication of the user who is still in the vehicle 10.

### Second Embodiment

In this second embodiment, in cases where a plurality of vehicles 10 of the same vehicle type (model) are associated with the same user ID, first information or a processed authentication face image already generated is diverted. Even if a vehicle 10 is assigned a vehicle ID different from that of another vehicle 10 for which first information has already been generated, it is possible to divert the already generated first information in the case where the vehicle 10 is of the same vehicle type. In other words, if the vehicle type is the same, the attributes of the vehicle 10 are considered to have a similar effect on users' face images, and hence, if the vehicle type and the user ID are the same, the first information or the processed authentication face image can be diverted. In addition, even in the case of different user IDs, the first information can be diverted to other users if their vehicles 10 are of the same vehicle type, because the attributes of their vehicles 10 are expected to have a similar effect on users' face images.

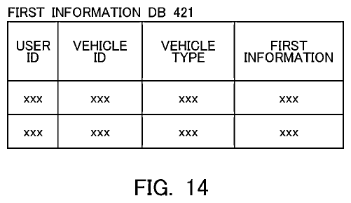

When first information is stored in the first information DB 421, the first information generation unit 417 of the user side server 40 stores the first information in association with a user ID, a vehicle ID, and a vehicle type. Here, FIG. 14 is a diagram illustrating an example of a table configuration of the first information DB 421 according to the second embodiment. The first information DB 421 stores relationships among user IDs, vehicle IDs, vehicle types, and first information. The information on the vehicle type is included in the information acquired by the vehicle information acquisition unit 412 from the vehicle ID server 60.

In addition, before generating a processed authentication face image, the face image processing unit 418 of the user side server 40 determines whether or not a record with the same vehicle type already exists in the first information DB 421. Then, when there is a record with the same vehicle type, the face image processing unit 418 of the user side server 40 generates a processed authentication face image based on the first information. In this way, in the case where the first information has already been generated for a vehicle 10 of the same vehicle type, the first information is subsequently diverted for the same vehicle type without generating new first information.

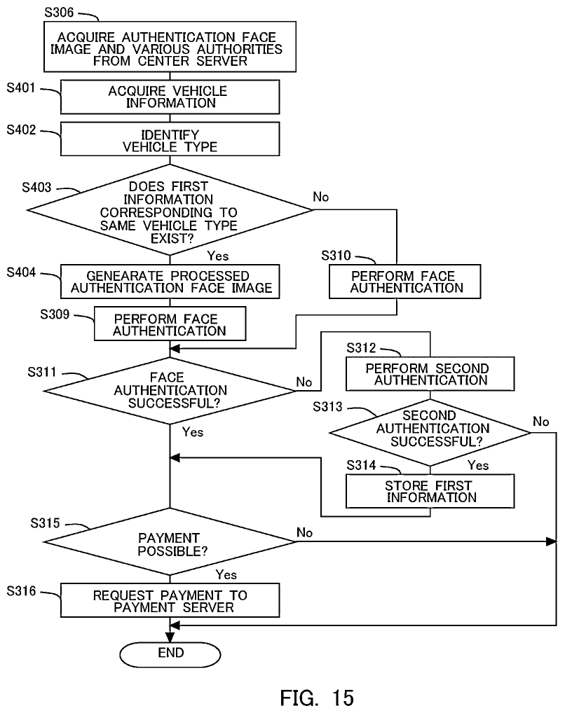

Next, the processing of face authentication in the user side server 40 will be described. FIG. 15 is a flowchart of the processing of face authentication in the user side server 40 according to the second embodiment. The processing illustrated in FIG. 15 is carried out in the user side server 40 at predetermined time intervals. Note that the processing illustrated in FIG. 15 is performed by each software module of the control unit 41, but in the following flowchart, description will be given assuming that the control unit 41 performs the processing. Here, note that steps in which the same processing as in FIG. 13 is performed will be denoted by the same reference signs, and the description thereof will be omitted. In addition, the processing up to step S306 is the same as in FIG. 13, and hence, FIG. 15 illustrates the processing from step S306 onwards.

In the routine illustrated in FIG. 15, when the processing of step S306 is completed, the routine proceeds to step S401. In step S401, the control unit 41 acquires the vehicle information associated with the vehicle ID from the vehicle ID server 60. The vehicle information includes information that can identify the vehicle, and includes, for example, information on the vehicle type, the vehicle name, the chassis number, or the number on the motor vehicle registration number certificate (vehicle number). Note that the vehicle information may include information that can identify the height and size of the vehicle, the color of the windshield, the color of the side glasses, the position of the wipers, the position of the sun visors, the position of the A-pillars, or the like. In addition, the vehicle information may also include information on the owner of the vehicle 10.

In step S402, the control unit 41 identifies the vehicle type from the vehicle information. The information on the vehicle type is included in the vehicle information. In step S403, the control unit 41 determines whether or not there exists first information corresponding to the same vehicle type. At this time, the control unit 41 accesses the first information DB 421 and determines whether or not there exists a record containing the same vehicle type as that identified in step S402. When this record exists, the control unit 41 determines that the first information corresponding to the same vehicle type exists. On the other hand, when this record does not exist, the control unit 41 determines that the first information corresponding to the same vehicle type does not exist. When an affirmative determination is made in step S403, the processing proceeds to step S404, whereas when a negative determination is made, the processing proceeds to step S310.

In step S404, the control unit 41 processes the authentication face image using the first information to generate a processed authentication face image. For example, the control unit 41 processes the authentication face image acquired from the center server 30 in such a manner that the processed authentication face image becomes a face image when the user is photographed through the windshield. Known techniques can be used for this processing.

In this way, by diverting the first information, the processed authentication face image corresponding to the vehicle type can be generated in advance, thus making it possible to improve the accuracy of face authentication. In addition, it is possible to reduce the load on the processing of generating the first information.

### Third Embodiment

In this third embodiment, first information is diverted in cases where the first information includes information that depends on a vehicle attribute, information that depends on a user attribute, and information that depends on a system attribute. In cases where first information includes the information depending on a vehicle attribute, for example, the first information may be available to other users who are riding in the vehicles 10 with the same vehicle attribute. For example, in cases where face authentication of a certain user is not successful due to information depending on a vehicle attribute, first information generated at that time can be diverted to face authentication of other users who are riding in the same type of vehicles.

In addition, in cases where first information includes the information depending on a user attribute, for example, the first information may be available when the same user is riding in another vehicle. The user attribute is an attribute related to the user such as, for example, the user wearing sunglasses or eyeglasses, the user wearing a mask, the user wearing a hat, the user wearing a beard, or the like. For example, it is assumed that the user owns a plurality of vehicles 10. The first information generated in the case where face authentication is not successful due to the information depending on a user attribute when the user is in a certain vehicle can be diverted to face authentication when the same user is in another vehicle.

Further, in cases where first information includes the information depending on a system attribute, for example, the first information may be available to another user or another vehicle when the system attribute is the same. The system attribute is an attribute related to the system 1 such as, for example, the mounting position of the camera 400, the angle of view of the camera 400, the distance from the camera 400 to the vehicle 10, etc. In cases where face authentication is performed in the same location, the system attribute has the same effect on the face authentication regardless of which user or vehicle 10 is involved. Note that the first information may be diverted not only in the same location but also in different locations, for example, in such a case where the relative angle between the camera 400 and the vehicle 10 is the same.

For example, if the mounting position of the camera 400 is off the front of the user, the angle of the face of the user captured in the user's face image could be tilted up, down, left or right from the front-facing state. Therefore, the accuracy of face authentication can be improved by having the control unit 41 generate a processed authentication face image in such a manner that the tilt of the face is corrected according to the mounting position of the camera 400. Then, the mounting position of the camera 400 is the same regardless of the user or the vehicle 10.

In addition, the face of the user captured in the user's face image may be distorted depending on the angle of view of the camera 400. Therefore, the accuracy of face authentication can be improved by having the control unit 41 generate a processed authentication face image in such a manner that the distortion is corrected according to the angle of view of the camera 400. Then, the angle of view of the camera 400 is the same regardless of the user or the vehicle 10.

Further, the face of the user captured in the user's face image may be distorted depending on the distance from the camera 400 to the vehicle 10. Therefore, the accuracy of face authentication can be improved by having the control unit 41 generate a processed authentication face image in such a manner that the distortion is corrected according to the distance between the camera 400 and the vehicle 10. Then, the distance from the camera 400 to the vehicle 10 is the same regardless of the user or the vehicle 10.

In this manner, the system attribute is the same regardless of the user or the vehicle 10. Therefore, in cases where first information includes the information depending on the system attribute, the first information can be diverted when the face authentication of another user is performed. Also, in cases where first information includes the information depending on the system attribute, the first information can be diverted when the same user rides in a different vehicle 10.

When generating first information, the first information generation unit 417 of the user side server 40 determines whether the first information corresponds to the information depending on an attribute of the vehicle 10, the information depending on an attribute of the user, or the information depending on an attribute of the system 1. The first information generation unit 417 may make this determination, for example, by image analysis. In addition, as another example, the first information generation unit 417 may make this determination using a pre-trained machine learning model. This machine learning model may be a model that, upon input of a user's face image, outputs whether the first information corresponds to the information depending on an attribute of the vehicle 10, the information depending on an attribute of the user, or the information depending on an attribute of the system 1. Then, when storing the first information in the first information DB 421, the first information generation unit 417 stores the first information together with information that can determine whether the first information corresponds to the vehicle attribute, the user attribute, or the system attribute.

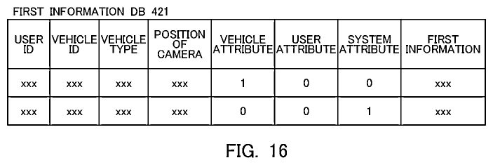

FIG. 16 is a diagram illustrating an example of a table configuration of the first information DB 421 according to the third embodiment. The first information DB 421 stores relationships among user IDs, vehicle IDs, vehicle types, camera positions, vehicle attributes, user attributes, system attributes, and first information. The vehicle type is shown as an example of a vehicle attribute. The position of a camera is shown as an example of an attribute of the system 1. The position of the camera may be indicated by, for example, the distance from the ground to the camera 400 and the angle thereof. In each of the fields of the vehicle attribute, the user attribute, and the system attribute, “1” is stored when the corresponding attribute is present, and “0” is stored when the corresponding attribute is not present. For example, in FIG. 16, the first information field of a record that stores “1” in the vehicle attribute contains information depending on the vehicle attribute.

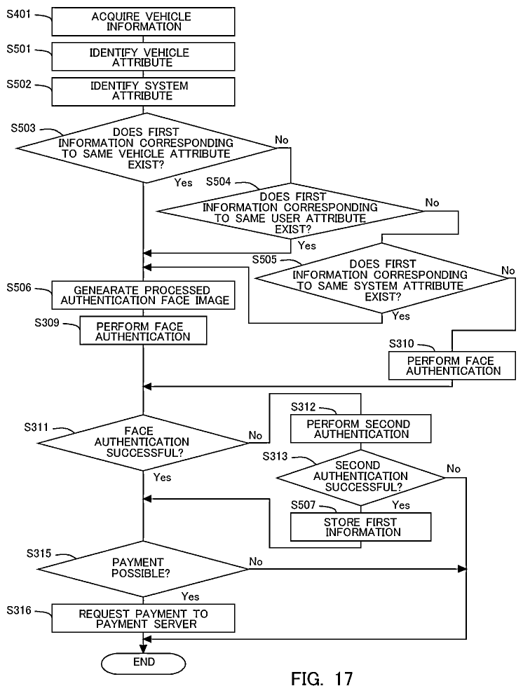

Next, the processing of face authentication in the user side server 40 will be described. FIG. 17 is a flowchart of the processing of face authentication in the user side server 40 according to the third embodiment. The processing illustrated in FIG. 17 is carried out in the user side server 40 at predetermined time intervals. Note that the processing illustrated in FIG. 17 is performed by each software module of the control unit 41, but in the following flowchart, description will be given assuming that the control unit 41 performs the processing. Here, note that steps in which the same processing as in FIG. 13 or FIG. 15 is performed will be denoted by the same reference signs, and the description thereof will be omitted. The processing up to step S401 is the same as in FIG. 15, and hence, FIG. 17 illustrates the processing from step S401 onwards.

In the routine illustrated in FIG. 17, when the processing of step S401 is completed, the routine proceeds to step S501. In step S501, the control unit 41 identifies a vehicle attribute. The vehicle attribute is included in the vehicle information acquired in step S401.

In step S502, the control unit 41 identifies a system attribute. The information on the system attribute may be measured in advance for each camera 400 and stored in the storage unit 42, for example.

In step S503, the control unit 41 determines whether or not first information corresponding to the same vehicle attribute exists in the first information DB 421. In other words, the control unit 41 determines whether or not there exists divertible first information corresponding to the vehicle attribute. The control unit 41 refers to the first information DB 421 to determine whether or not there exists a record in which the information on the vehicle type is the same and “1” is stored in the vehicle attribute field. When an affirmative determination is made in step S503, the processing proceeds to step S506, whereas when a negative determination is made, the processing proceeds to step S504.

In step S504, the control unit 41 determines whether or not first information corresponding to the same user attribute exists in the first information DB 421. That is, the control unit 41 determines whether or not there exists divertible first information corresponding to the user attribute. The control unit 41 refers to the first information DB 421 and determines whether or not there exists a record in which the user ID is the same and “1” is stored in the user attribute field. When an affirmative determination is made in step S504, the processing proceeds to step S506, whereas when a negative determination is made, the processing proceeds to step S505.

In step S505, the control unit 41 determines whether or not first information corresponding to the same system attribute exists in the first information DB 421. That is, the control unit 41 determines whether or not there exists divertible first information corresponding to the system attribute. The control unit 41 refers to the first information DB 421 and determines whether or not there exists a record in which the information on the position of the camera is the same and “1” is stored in the system attribute field. When an affirmative determination is made in step S505, the processing proceeds to step S506, whereas when a negative determination is made, the processing proceeds to step S310.

In step S506, the control unit 41 generates a processed authentication face image by processing the authentication face image using the first information. For example, the control unit 41 generates a processed authentication face image according to at least one attribute among the vehicle attribute, the user attribute, and the system attribute.

In addition, in the routine illustrated in FIG. 17, when a positive determination is made in step S313, the processing proceeds to step S507. In step S507, the control unit 41 stores the first information in the first information DB 421. The control unit 41 stores the first information in the first information DB 421 in association with the vehicle ID and the user ID. Also, the control unit 41 determines a corresponding attribute among the vehicle attribute, the user attribute, and the system attribute, and stores “1” in a corresponding field among the vehicle attribute, the user attribute, and the system attribute of the first information DB 421.

As described above, according to this third embodiment, it is possible to divert past information by generating a processed authentication face image according to information depending on at least one of the vehicle attribute, the user attribute, and the system attribute. Therefore, the accuracy of face authentication can be improved. In addition, it is possible to reduce the load of generating the first information.

### Fourth Embodiment

In this fourth embodiment, when face authentication is not successful, a face image of the user is further acquired. The reacquisition of the face image of the user is started after face authentication is not successful, and is carried out, for example, during a period in which a second authentication is performed. That is, the reacquisition of the user's face image and the second authentication are performed in parallel. This allows the image of the face of the user performing the second authentication to be kept as a record. Therefore, evidence in case of illegal use can be left. In addition, it is conceivable that first information is more easily generated for a user's face image captured later than a user's face image captured first. Accordingly, the accuracy of the first information can be improved. Further, by capturing the user's face image in parallel with the second authentication, the time required for processing can be shortened as compared to capturing the user's face image after the second authentication is successful. Note that the reacquired user's face image does not necessarily have to be used for generating the first information. For example, the user's image reacquired as evidence may simply be stored in the storage unit 42. Also, as another example, the first information may be generated using only the reacquired user's face image.

The control unit 41 reacquires the user's face image, for example, after a negative determination is made in step S311 of the routine shown in FIG. 13, until the processing in step S312 or step S313 is started. The user's face image thus reacquired is stored in the storage unit 42 in association with the user ID and the vehicle ID so that it can be recognized as a reacquired image. In this case, the user's face image may simply be stored as evidence, or may be used when the first information is generated in step S314.

Here, it is conceivable that in the case where the keypad 500 is located outside the vehicle 10, the user may put his or her face out of the vehicle or may get off the vehicle 10 once, when inputting a password number to the keypad 500. This allows the user's face image to be captured without being affected by the vehicle attribute. In this case, information depending on the vehicle attribute cannot be obtained, but information depending on the user attribute and information depending on the system attribute can be obtained with higher accuracy. Accordingly, the accuracy of the first information can be improved because it is easier to determine which of the vehicle attribute, the user attribute, or the system attribute is responsible for the failure of face authentication. In addition, the face authentication may be performed again based on the user's face image reacquired without being affected by the vehicle attribute. Thus, the authentication accuracy can be improved by performing the face authentication again in parallel with the second authentication.

### OTHER EMBODIMENTS

The above-described embodiments are merely examples, but the present disclosure can be implemented with appropriate modifications without departing from the spirit thereof. The processing and/or means (devices, units, etc.) described in the present disclosure can be freely combined and implemented as long as no technical contradiction occurs. In addition, the processing described as being performed by one device or unit may be shared and performed by a plurality of devices or units. Alternatively, the processing described as being performed by different devices or units may be performed by a single device or unit. In a computer system, it is possible to flexibly change the hardware configuration (server configuration) that can achieve each function of the computer system.

For example, one server may have the functions of two or more servers among the center server 30, the user side server 40, the association management server 50, the vehicle ID server 60, and the payment server 70. For example, the center server 30 and the user side server 40 may be a single server. Similarly, the center server 30 and the association management server 50 or the vehicle ID server 60 may be a single server. At least a part of the processing of the center server 30 may be executed by the user side server 40. At least a part of the processing of the user side server 40 may be executed by the center server 30.

In addition, first information may be generated by the control unit 31 of the center server 30. Also, a processed authentication face image may be generated by the control unit 31 of the center server 30. In this case, when authentication is not successful in the user side server 40, the user side server 40 may transmit a user's face image to the center server 30. Then, a processed authentication face image generated in the center server 30 may be transmitted from the center server 30 to the user side server 40.

In the above-described embodiments, payment is requested to the payment server 70 when face authentication is successful, but the user side server 40 can execute the various kinds of authorities of the user without being limited to payment.

The present disclosure can also be realized by supplying a computer program implementing the functions described in the above-mentioned embodiments to a computer, and having one or more processors of the computer read and execute the program. Such a computer program may be provided to the computer by a non-transitory computer readable storage medium that can be connected to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read only memory (ROM), a random access memory (RAM), an EPROM, an EEPROM, a magnetic card, a flash memory, an optical card, or any type of medium suitable for storing electronic commands or instructions.

What is claimed is:

1. A computer networking apparatus including a controller configured to:
acquire a data of a user of a vehicle;
acquire a first image that is associated with the data of the user;
acquire a second image that is generated by photographing the user of the vehicle with a camera disposed outside the vehicle;
perform calculation based on a comparison between the first image and the second image; and
acquire, from the second image, a data that is used in the next and subsequent calculation in response to the calculation not being successful.

2. An information processing apparatus including a controller configured to:
acquire user identification information that is identification information of a user of a vehicle;
acquire an authentication face image that is an image associated with the user identification information and is an image of a face for authentication of the user of the vehicle;
acquire a user's face image that is an image generated by photographing the user of the vehicle with a camera disposed outside the vehicle;
perform face authentication based on a comparison between the authentication face image and the user's face image; and
acquire, from the user's face image, first information that is information to be used in the next and subsequent face authentications in response to the face authentication not being successful.

3. The information processing apparatus according to claim 2, wherein
the controller performs a second authentication other than the face authentication in response to the face authentication not being successful, and acquires the first information from the user's face image in response to the second authentication being successful.

4. The information processing apparatus according to claim 2, wherein
the controller performs, in response to the existence of the first information, the face authentication based on a comparison between a processed authentication face image, which is the authentication face image reflecting the first information, and the user's face image.

5. The information processing apparatus according to claim 4, wherein
the controller generates the processed authentication face image by processing the authentication face image in accordance with the first information.

6. The information processing apparatus according to claim 2, wherein
the controller stores the first information in a memory so as to be usable for face authentication when the user uses the vehicle.

7. The information processing apparatus according to claim 2, wherein
the first information includes at least one of information depending on an attribute of a first user, information depending on an attribute of a first vehicle, and information depending on an attribute of a first system that performs the face authentication.

8. The information processing apparatus according to claim 7, wherein
the controller stores the first information in a memory so as to be usable for face authentication of the first user, in response to the fact that the first information includes the information depending on an attribute of the first user.

9. The information processing apparatus according to claim 7, wherein
the controller stores the first information in a memory so as to be usable for face authentication of a second user of a second vehicle having the same attribute as that of the first vehicle, in response to the fact that the first information includes the information depending on an attribute of the first vehicle.

10. The information processing apparatus according to claim 7, wherein
the controller stores the first information in a memory so as to be usable for face authentication of a second user in a second system that performs the same face authentication as in the first system, in response to the fact that the first information includes the information depending on an attribute of the first system.

11. The information processing apparatus according to claim 3, wherein
the controller acquires, in response to performing the second authentication, the face image of the user again after the face authentication is not successful and before the second authentication is completed.

12. An information processing method for causing a computer to:
acquire user identification information that is identification information of a user of a vehicle;
acquire an authentication face image that is an image associated with the user identification information and is an image of a face for authentication of the user of the vehicle;
acquire a user's face image that is an image generated by photographing the user of the vehicle with a camera disposed outside the vehicle;
perform face authentication based on a comparison between the authentication face image and the user's face image; and
acquire, from the user's face image, first information that is information to be used in the next and subsequent face authentications in response to the face authentication not being successful.

13. The information processing method according to claim 12, further causing the computer to:
perform a second authentication other than the face authentication in response to the face authentication not being successful; and
acquire the first information from the user's face image in response to the second authentication being successful.

14. The information processing method according to claim 12,
further causing the computer to perform, in response to the existence of the first information, the face authentication based on a comparison between a processed authentication face image, which is the authentication face image reflecting the first information, and the user's face image.

15. The information processing method according to claim 14, further causing the computer to generate the processed authentication face image by processing the authentication face image in accordance with the first information.

16. The information processing method according to claim 12, further causing the computer to store the first information in a memory so as to be usable for face authentication when the user uses the vehicle.

17. The information processing method according to claim 12, wherein
the first information includes at least one of information depending on an attribute of a first user, information depending on an attribute of a first vehicle, and information depending on an attribute of a first system that performs the face authentication.

18. The information processing method according to claim 17, further causing the computer to store the first information in a memory so as to be usable for face authentication of the first user in response to the fact that the first information includes the information depending on an attribute of the first user.

19. The information processing method according to claim 17, further causing the computer to store the first information in a memory so as to be usable for face authentication of a second user of a second vehicle having the same attribute as that of the first vehicle, in response to the fact that the first information includes the information depending on an attribute of the first vehicle.

20. The information processing method according to claim 17, further causing the computer to store the first information in a memory so as to be usable for face authentication of a second user in a second system that performs the same face authentication as in the first system, in response to the fact that the first information includes the information depending on an attribute of the first system that performs the face authentication.
